(19) United States
(12) Patent Application Publication
(10) Pub. No.: US 2008/0036741 A1
(43) Pub. Date: Feb. 14, 2008

(54) KEYBOARD-VIDEO-MOUSE SWITCH CAPABLE OF BEING CONTROLLED BY HAND-HELD DEVICE AND METHOD THEREOF

(75) Inventors: Chih-Tao Hsieh, Shijr City (TW); Chien-Wen Yu, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/463,988

(22) Filed: Aug. 11, 2006

(51) Int. Cl. G06F 3/02

(52) U.S. Cl. 345/168

(57) ABSTRACT

A hand-held device capable of controlling a keyboard-video-mouse switch and method thereof is disclosed. The hand-held device shows a control menu for inputting a control signal to control the keyboard-video-mouse switch or particularly an on screen display circuit of the keyboard-video-mouse switch. The keyboard-video-mouse switch includes a processor and a second interface. The hand-held device includes a menu generator, a user interface and a first interface. The menu generator generates a control menu. The user interface shows the control menu for inputting a control signal into the hand-held device. The first interface transmits the control signal to the second interface of the keyboard-video-mouse switch. The keyboard-video-mouse switch receives the control signal via the second interface. The second interface transmits a response signal of the control signal from the processor of the keyboard-video-mouse switch to the hand-held device via the first interface.

### FIELD OF THE INVENTION

The present invention generally relates to a keyboard-video-mouse switch capable of being controlled by a hand-held device, and more particularly to a keyboard-video-mouse switch, having an on screen display circuit, capable of being controlled by a hand-held device and method thereof.

### BACKGROUND OF THE INVENTION

Recently, a keyboard-video-mouse (KVM) switch has been widely used for controlling a plurality of computers from a console coupled thereto. A user can select and control anyone of the computers coupled with the keyboard-video-mouse switch or control the KVM switch at the console. For selecting and controlling the computers, such as, invoking an on screen display (OSD) menu to select one of the computers; running a broadcasting function for selected computers via the OSD menu, can be illustrated. For controlling the KVM switch, such as, buzzer on/off via a hotkey, an auto scanning operation for monitoring portion or all of the computers can be examples. For practically operating and maintaining the KVM switch system, the user might have lots of time that he must go around to inspect and cannot stay at the console all the time. Some KVM switch might provide a notice function that the user can receive an alert message such as that one coupled computer has been attacked through the KVM switch by a hacker from outside of the intranet or an error message generated by the KVM switch indicating that a detected operation error in the KVM switch system by a hand-held device he carries about.

However, the aforesaid function is passively receiving the notice by the hand-held device but cannot provide a remote control access to the KVM switch for the user once he gets the notice. Although, a KVM remote controller has been publicly well known already, such KVM remote controller only provides a monitor switching function to the KVM switch for being controlled. Furthermore, operating the KVM remote controller is like using a TV remote controller; therefore, switching the KVM to couple with the different computers is simply like switching the different channel of the TV. Accordingly, such KVM remote controller cannot receive any notice or message from the KVM switch. Meanwhile, it transmits the switch command to the KVM switch only by way of radio frequency (RF), which has to be used near the KVM switch and to be aimed at the RF receiver of the KVM switch.

Consequently, there is a need to develop a keyboard-video-mouse switch capable of being controlled by a hand-held device and method thereof. The hand-held device can shows a control menu on its user interface for inputting a control signal to control the keyboard-video-mouse switch or particularly an on screen display circuit of the KVM switch through the hand-held device.

### SUMMARY OF THE INVENTION

To solve the foregoing drawbacks in the prior art, it is an objective of the present invention is to provide a keyboard-video-mouse switch capable of being controlled by a hand-held device and method thereof.

Another objective of the present invention is to provide a hand-held device having a user interface to show a control menu for inputting a control signal to control the keyboard-video-mouse switch or particularly an on screen display circuit of the keyboard-video-mouse switch via the hand-held device.

The keyboard-video-mouse switch includes a keyboard/mouse controller for receiving a keyboard/mouse signal, a first switching device for routing the keyboard/mouse signal, a video signal to/from the computer, a processor and a second interface, wherein the second interface receives a control signal from hand-held device via the first interface wirelessly. The processor transmits a response signal of the control signal to the hand-held device via the second interface and the first interface for showing a notification on the user interface of the hand-held device. The second interface of the keyboard-video-mouse switch can be a network interface for communicating with the first interface via a network. The hand-held device includes a menu generator, a user interface and a first interface. The menu generator generates a control menu. The user interface shows the control menu for inputting a control signal into the hand-held device. The first interface coupled to the menu generator transmits the control signal to the keyboard-video-mouse switch. The menu generator can be firmware downloaded from a network the hand-held device coupled with or hardware inside the hand-held device. The present invention provides a method of for controlling a keyboard-video-mouse switch by using a hand-held device to accomplish the aforementioned objectives.

The method comprises the steps of:

generating a control menu by a menu generator;

connecting the hand-held device to the keyboard-video-mouse switch according to the menu generator;

inputting a control signal into the hand-held device via a user interface; and

transmitting the control signal to the keyboard-video-mouse switch.

After the step of transmitting the control signal, the method of present invention further includes a step of receiving a response signal from the keyboard-video-mouse switch to the hand-held device. The response signal is generated by a processor of the keyboard-video-mouse switch for showing on the user interface to notify the hand-held device user.

According to the present invention, the hand-held device can generate the control menu by the firmware or the hardware on its own, otherwise by receiving an on screen display menu signal generated by the on screen display circuit of the keyboard-video-mouse switch to be controlled. The hand-held device user can inputs the control signal into the hand-held device via the user interface. Accordingly, controlling the keyboard-video-mouse switch by the hand-held device can be achieved.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a simple block diagram of a keyboard-video-mouse (KVM) switch having an on-screen display (OSD) circuit for generating the on-screen display menu on the display according to prior art;

FIG. 2 illustrates a functional block diagram of a keyboard-video-mouse switch and a hand-held device for controlling the keyboard-video-mouse switch according to the present invention;

FIG. 3 illustrates a functional block diagram of a console module coupled with a keyboard-video-mouse switch and a hand-held device for controlling the keyboard-video-mouse switch according to the present invention;

FIG. 4 shows a three-dimensional picture view of a keyboard-video-mouse switch system and a hand-held device for controlling keyboard-video-mouse switch wirelessly;

FIG. 5 shows a three-dimensional picture view of a keyboard-video-mouse switch system and a hand-held device for controlling keyboard-video-mouse switch mainly through Internet or intranet; and

FIG. 6 shows a flow chart of the method of controlling a keyboard-video-mouse switch optionally by using a hand-held device according to the present invention.

### DETAILED DESCRIPTION OF THE PREFERRED EMBODIMENTS

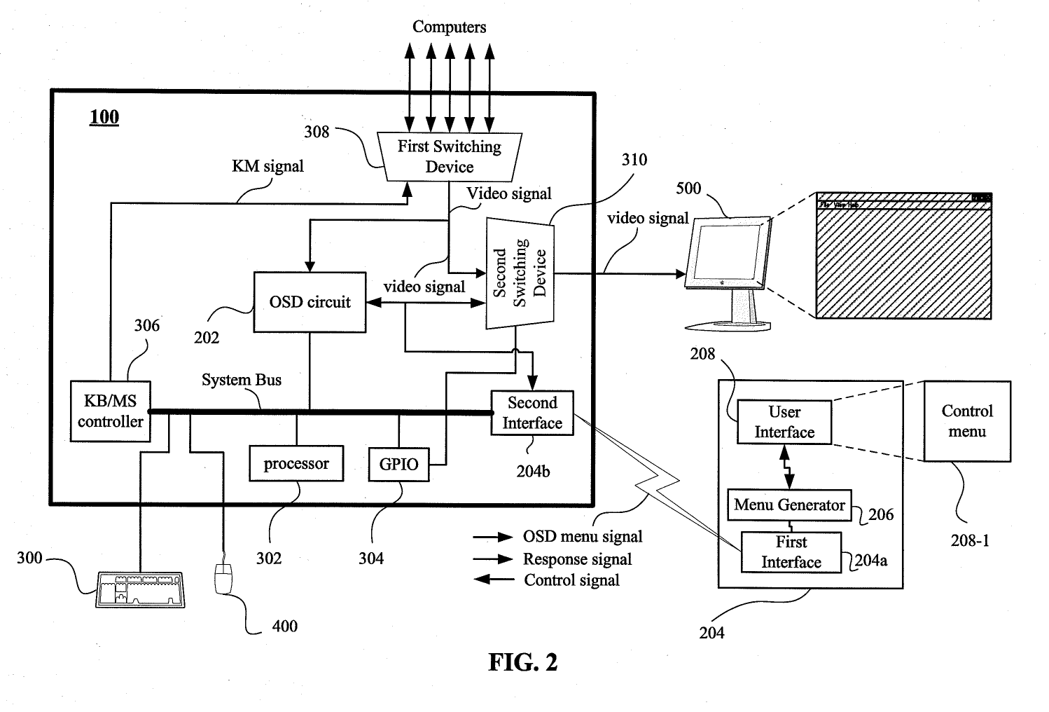

Please refer to FIG. 2, which illustrates a functional block diagram of a keyboard-video-mouse (KVM) switch 100 and a hand-held device 204 for controlling the KVM switch 100 according to the present invention. The KVM switch 100 includes an on screen display circuit 202, a second interface 204b, a processor 302, a GPIO unit 304, a keyboard/mouse (KB/MS) controller 306, a first switch 308 and a second switch 310. The hand-held device 204 includes a menu generator 206, a user interface 208 and a first interface 204a. The KVM switch 100 is coupled with a keyboard 300 and a mouse 400 via the keyboard/mouse (KB/MS) controller 306 to receive the keyboard/mouse signal. Moreover, the KVM switch 100 is coupled with a plurality of computers (not shown in FIG. 2) via the first switch 308 to route the keyboard/mouse signal to the computers and video signals from the computers coupled thereto. Meanwhile, the second interface 204b receives a control signal from hand-held device 204 via the first interface 204a wirelessly. The first switch 308 and the on screen display circuit 202 of the KVM switch 100 are coupled with a display 500 via the second switch 310. The second switch 310 receives commands from the processor 302 via the GPIO unit 304 to selectably output the video signals from the computers or an on screen display menu signal generated from the on screen display circuit 202 to the display 500.

According to prior art, if a user wants to control the KVM switch 100 and the computers (not shown in FIG. 2) coupled thereto, such as, invoking an on screen display (OSD) menu generated by the OSD circuit 202 to select one of the computers; run a broadcasting function for selected computers via the OSD menu; control buzzer on/off via a hotkey; run an auto scanning operation for monitoring portion or all of the computers, the user has to be near the console, which includes the keyboard 300, the mouse 400 and the display 500 to operate the keyboard 300 or the mouse 400 to invoke the OSD menu, etc and watch his operation on the display 500.

According to the present invention, a user is going to control the KVM switch 100 and the computers coupled thereto. Firstly, the user uses the menu generator 206 of the hand-held device 204 to generate a control menu 208-1. Then, the user interface 208 shows the control menu 208-1 for the user to input a control signal into the hand-held device 204. The first interface 204a coupled to the menu generator 206 transmits the control signal to the second interface 204b of the KVM switch 100. The KVM switch 100 receives the control signal via the second interface 204b. Therefore, the user can control the KVM switch 100 by using the hand-held device 204 and the computers as same as he operates the keyboard 300 or the mouse 400 near the console as aforementioned. Therefore, to run the aforesaid broadcasting function, auto scanning function, or control the buzzer on/off can be achieved by using the hand-held device 204 even when the user is not at the console.

In one embodiment of the present invention, the control menu 208-1 can be an on screen display menu generated by the on screen display circuit 202. In this case, once the user wants to control the KVM switch 100 and give such command to the hand-held device 204. The hand-held device 204 firstly receives the on screen display menu signal generated by the on screen display circuit 202. The menu generator 206 generates the control menu 208-1, i.e. the “on screen display menu” originally shown on the display 500, but now to show it on the user interface 208. As aforementioned, the user can remotely control the KVM switch 100 and the computers coupled thereto by inputting the control signal into the hand-held device 204 that he carries about even though the user goes around to inspect when he cannot stay at the console. Alternatively, the menu generator 206 also can be realized by firmware, which can be downloaded from a network that the hand-held device 204 is coupled with, or a hardware circuit designed in the hand-held device. Moreover, the processor 302 can transmit a response signal back to the hand-held device 204 to show the operation status or a notifying message on the user interface 208 to inform the user of the hand-held device 204. The aforesaid control signal, the aforesaid on screen display menu signal and the aforesaid response signal are transceived between the first interface 204a of the hand-held device 204 and the second interface 204b of the KVM switch 100.

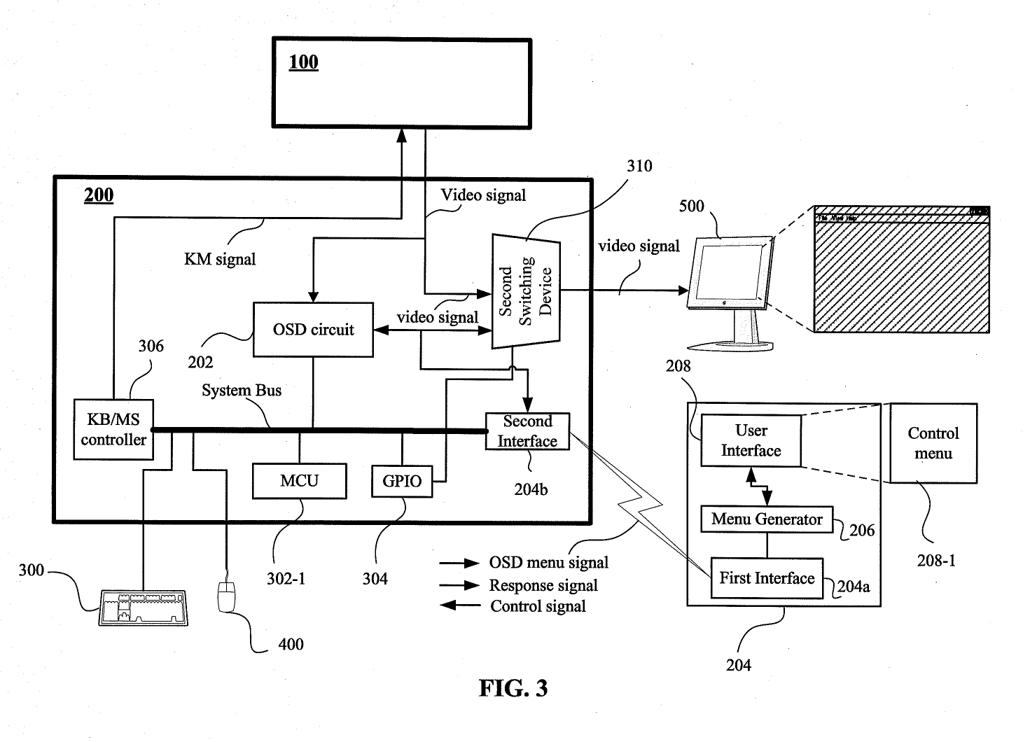

Please refer to FIG. 3, which illustrates a functional block diagram of a console module 200 coupled with a KVM switch and a hand-held device 204 for controlling the KVM switch according to the present invention. In a KVM switch system, an on screen display circuit 202 is designed to be located in the console module 200, which is for extending the transmission distance between a console and the KVM switch 100 or for transforming process of KVM signal transmission format sometimes. Accordingly, the second interface 204b can be selectably set up in the console module 200 or still in the KVM switch 100 as described in FIG. 2 to receive the control signal from the first interface 204a of the hand-held device 204 or transmit the on screen display menu signal of the on screen display circuit 202 or the response signal of the micro control unit (MCU) 302-1 back to the hand-held device 204 as similarly shown in FIG. 2.

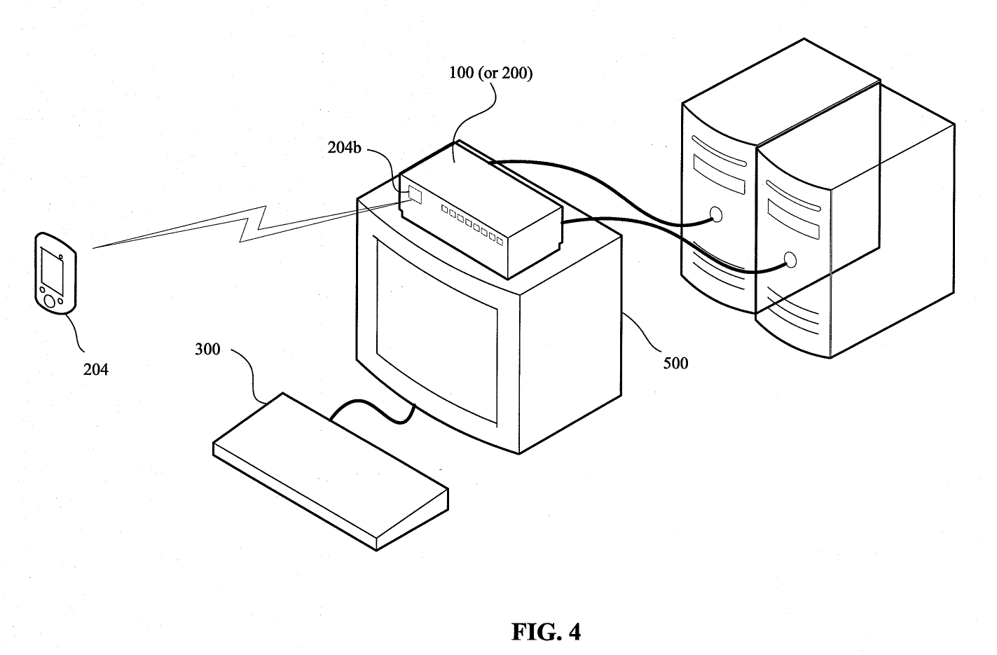

Please refer to FIG. 4 with FIG. 2. FIG. 4 shows that the user remotely controls the KVM switch 100 with the hand-held device 204 wirelessly, for example, by way of radio frequency (RF), Bluetooth, infrared rays (IR). In this embodiment, the aforesaid first interface 204a and the second interface 204b are two wireless transceivers corresponding to each other. The user inputs the aforesaid control signal into the hand-held device 204 via the user interface 208 thereof. The second interface 204b receives the control signal transmitted from the first interface 204a and transmits the control signal to the KVM switch 100. As well as operating a keyboard 300 and a mouse 400 at the console, the user can control the KVM switch 100 by using the control menu 208-1 he sees. Moreover, the response signal transmitted back to the hand-held device 204 from a processor 302 of the KVM switch 100 can be shown in the control menu 208-1 on the user interface 208 to notify the user. Please refer to FIG. 4 with FIG. 3, the second interface 204b is now located in the console module 200 shown in FIG. 4. Meanwhile, the console module 200 is coupled with the KVM switch 100, which now is omitted in FIG. 4. In such embodiment, the control signal from the hand-held device 204 inputted by the user will be firstly transmitted to the console module 200, and then the console module 200 transfers the control signal to the KVM switch 100.

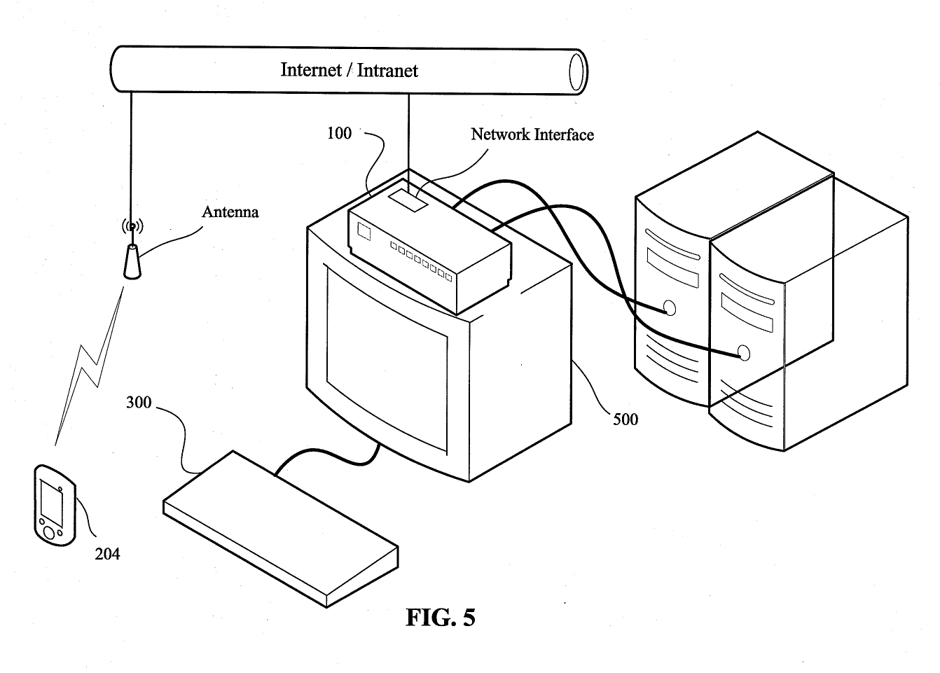

Please refer to FIG. 5 with FIG. 2. FIG. 5 shows that a user can remotely control the KVM switch 100 with the hand-held device 204 more powerfully through a network, such as intranet or Internet, which interconnects the hand-held device 204 and the KVM switch 100. The hand-held device 204 is got on Internet or intranet with its wireless web access ability through an antenna of Internet or intranet. Accordingly, the user can actively control the KVM switch 100 and the computers coupled thereto by the hand-held device 204 that he carries about even though the user is far away from the console. Once the user receives an alert message or an error message from the KVM switch 100, actively invoking the control menu 208-1 to access the KVM switch 100 for controlling thereof immediately can be realized. Please refer to FIG. 5 with FIG. 3. In such embodiment, the control signal from the hand-held device 204 inputted by the user will be firstly transmitted to the KVM switch 100 via Internet or intranet, and then the KVM switch 100 transfers the control signal to the console module 200. Accordingly, the response signal from the MCU 302-1 of the console module 200 is transmitted back to the hand-held device 204 via the KVM switch 100, Internet or intranet via the second interface 204b and the first interface 204a of the hand-held device 204. The second interface 204b of the KVM switch 100 can be a Network Interface for connecting to the Internet or intranet and communicating with the with the first interface 204a Internet or intranet.

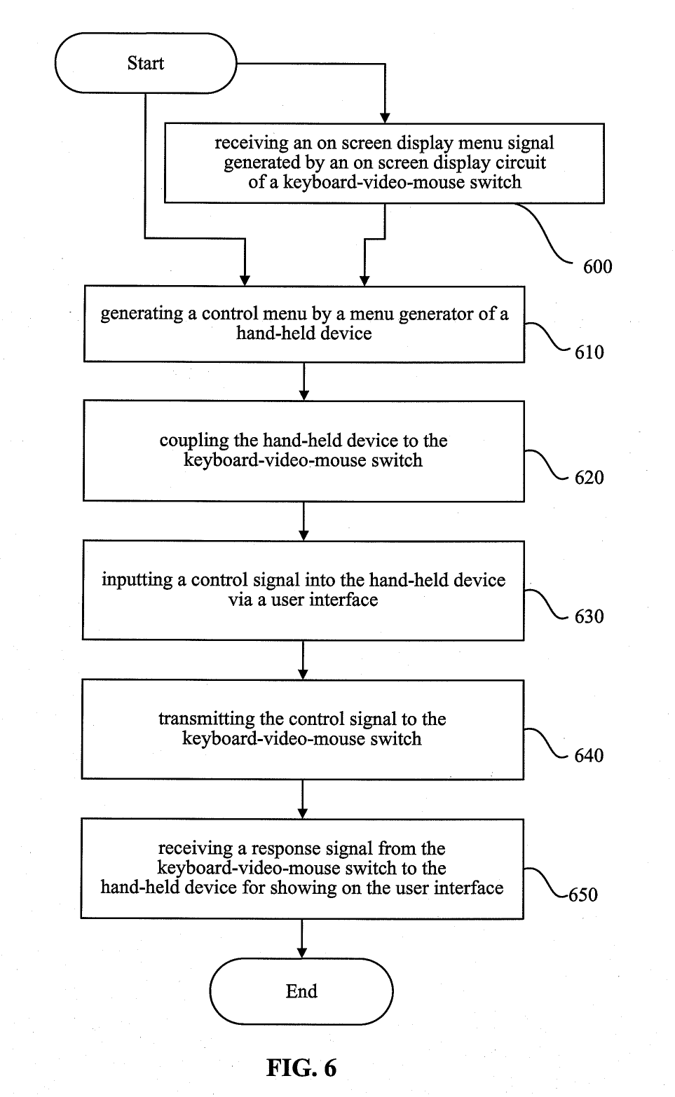

Please refer to FIG. 6, which shows a flow chart of the method of controlling a keyboard-video-mouse switch optionally having an on screen display circuit using a hand-held device according to the present invention. The method includes the following steps:

Step 610, generating a control menu by a menu generator;

Step 620, coupling the hand-held device to the keyboard-video-mouse switch;

Step 630, inputting a control signal into the hand-held device via a user interface; and

Step 640, transmitting the control signal to the keyboard-video-mouse switch.

After the step of transmitting the control signal, the method of present invention further includes a step 650 of receiving a response signal from the keyboard-video-mouse switch to the hand-held device. The response signal can be generated by a processor of the keyboard-video-mouse switch for showing on the user interface 208 to notify the user of the hand-held device 204.

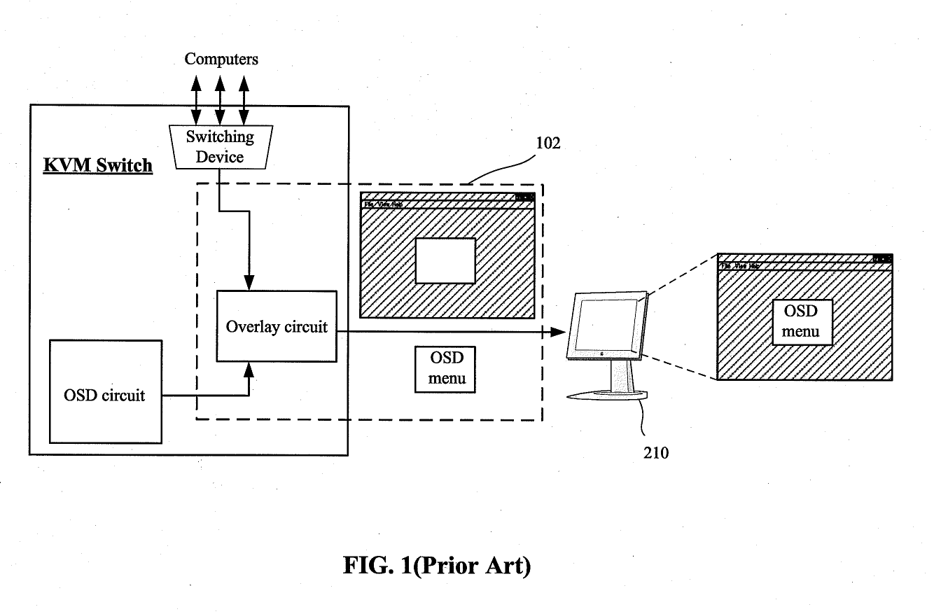

In one embodiment of the present invention when the control menu is an on screen display menu generated by the on screen display circuit 202 in FIG. 1 as aforementioned. The method of present invention further includes a step 600 of receiving an on screen display menu signal generated by the on screen display circuit 202 to generate the control menu before the step 610 of generating the control menu.

Consequently, actively receiving an alert or an error message from a KVM switch, to run aforesaid broadcasting function, auto scanning function, or control the buzzer on/off an more functions can be achieved by using a hand-held device even though the user is far away from the console according to the present invention.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A KVM switch, having at least one computer coupled thereto, capable of being remotely controlled by a hand-held device having a first interface and a user interface, the KVM switch comprises:
a keyboard/mouse controller, receiving a keyboard/mouse signal;
a first switching device, routing the keyboard/mouse signal to the computer and a video signal from the computer;
a processor; and
a second interface, wherein the second interface receives a control signal from hand-held device via the first interface wirelessly.

2. The KVM switch of claim 1, wherein the processor transmits a response signal of the control signal to the hand-held device via the second interface and the first interface for showing a notification on the user interface of the hand-held device.

3. The KVM switch of claim 1, wherein the second interface is a network interface, communicating with the first interface via a network.

4. The KVM switch of claim 1, wherein the user interface shows a control menu for inputting the control signal into the hand-held device.

5. The KVM switch of claim 4, wherein the control menu is generated by a menu generator of the hand-held device.

6. The KVM switch of claim 5, wherein the menu generator is a firmware.

7. The hand-held device of claim 6, wherein the firmware is downloaded from a network the hand-held device coupled with.

8. The hand-held device of claim 5, wherein the menu generator is a hardware.

9. The KVM switch of claim 5, further comprising an on screen display circuit, receiving the control signal via the second interface.

10. The KVM switch of claim 9, wherein the control menu is an on screen display menu generated by the on screen display circuit.

11. The KVM switch of claim 9, wherein the menu generator generates the on screen display menu by receiving an on screen display menu signal generated by the on screen display circuit via the second and the first interface.

12. A hand-held device capable of controlling a keyboard-video-mouse switch, the hand-held device comprising:
a menu generator, generating a control menu;
a user interface, showing the control menu for inputting a control signal into the hand-held device; and
a first interface, coupled to the menu generator to transmit the control signal to the keyboard-video-mouse switch.

13. The hand-held device of claim 12, wherein the keyboard-video-mouse switch comprises a second interface, receiving the control signal and transmitting a response signal of the control signal to the hand-held device via the first interface.

14. The hand-held device of claim 13, wherein the response signal is generated by a processor of the keyboard-video-mouse switch.

15. The hand-held device of claim 12, wherein the menu generator is a firmware.

16. The hand-held device of claim 15, wherein the firmware is downloaded from a network the hand-held device coupled with.

17. The hand-held device of claim 12, wherein the menu generator is a hardware.

18. The hand-held device of claim 12, wherein keyboard-video-mouse switch further comprises an on screen display circuit, receiving the control signal via the second interface.

19. The hand-held device of claim 18, wherein the control menu is an on screen display menu.

20. The hand-held device of claim 18, wherein the menu generator generates the on screen display menu by receiving an on screen display menu signal generated by the on screen display circuit via the second and the first interface.

21. A method for controlling a keyboard-video-mouse switch by using a hand-held device, the method comprising steps of:
generating a control menu by a menu generator;
coupling the hand-held device to the keyboard-video-mouse switch;
inputting a control signal into the hand-held device via a user interface; and
transmitting the control signal to the keyboard-video-mouse switch.

22. The method of claim 21, further comprising a step of receiving a response signal from the keyboard-video-mouse switch to the hand-held device for showing on the user interface after the step of transmitting the control signal.

23. The method of claim 22, wherein the response signal is generated by a processor of the keyboard-video-mouse switch.

24. The method of claim 21, wherein the control menu is an on screen display menu generated by an on screen display circuit of the keyboard-video-mouse switch.

25. The method of claim 24, further comprising a step of receiving an on screen display menu signal to generate the control menu before the step of generating the control menu.

26. The hand-held device of claim 21, wherein the menu generator is a firmware.

27. The hand-held device of claim 21, wherein the firmware is downloaded from a network the hand-held device coupled with.

28. The hand-held device of claim 21, wherein the menu generator is a hardware.
